(19) United States
(12) Patent Application Publication
(10) Pub. No.: US 2010/0326392 A1
(43) Pub. Date: Dec. 30, 2010

(54) FILTER SYSTEM

(76) Inventors: Uwe Grass, Stuttgart (DE); Mike Schmid, Tubingen (DE); Andreas Widmaier, Herrenberg (DE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 12/809,283

(22) PCT Filed: Dec. 4, 2008
(86) PCT No.: PCT/EP2008/066750

§ 371 Date: Sep. 1, 2010

(30) Foreign Application Priority Data
Dec. 21, 2007 (DE) 10 2007 062 101.0

(51) Int. Cl. F01M 11/03; B01D 35/04; B01D 29/00; B01D 29/52

(52) U.S. Cl. 123/196 A; 210/295; 210/236; 210/253

(57) ABSTRACT

A liquid filter system, having an annular first filter element that separates a crude side from a clean side in a first filter chamber and a first plug, which projects axially and eccentrically with respect to a longitudinal center axis of the first filter element and extends axially into a first plug receptacle after insertion in the first filter chamber. A annular second filter element that separates a crude side from a clean side in a second filter chamber and a second plug, which projects axially and eccentrically with respect to a longitudinal center axis of the second filter element and extends axially into a second plug receptacle after insertion in the second filter chamber, and wherein the filter elements differ from one another at least in that the plugs have at least one of different eccentricities and shapes.

The present invention relates to a filter system for filtering at least one liquid, especially of an internal combustion engine and/or a vehicle. Furthermore, the invention relates to an internal combustion engine or a vehicle comprising such a filter system.

From EP 1 229 985 B1, a filter device is known which concerns preferably an oil filter for cleaning lubricating oil, in particular for combustion engines of motor vehicles. The filter device has a filter housing for receiving a ring-shaped filter element, wherein the filter housing has an inlet on the crude side and an outlet on the clean side. In the inserted state, the filter element separates a crude chamber communicating with the inlet from a clean chamber communicating with the outlet. Further, the filter housing of the known filter device has a discharge channel which communicates with the crude chamber and which forms a plug receptacle for an axially and eccentrically projecting plug formed on the filter element, and into which the plug is inserted in the inserted state of the filter element. The plug thus closes the discharge channel when the filter element is properly placed into the filter housing. For a simplified finding and inserting of the plug into the plug receptacle, the known filter device is provided with a helically ascending or descending ramp arranged concentrically on the housing, wherein the plug receptacle formed by an inlet region of the discharge channel is arranged between a lower ramp end and an upper ramp end. When screwing on a cover, together with which the filter element is inserted or screwed in, due to the rotational movement of the filter element and the sliding of the plug along the ramp, the plug finds the plug receptacle automatically and can penetrate therein and close the discharge channel. In a particularly advantageous embodiment of the known filter device, the ramp and the plug can interact according to the key-lock-principle in such a manner that only a filter element provided with a plug adapted to the ramp can be used with the housing of the known filter device in such a manner that the plug finds the plug receptacle automatically when the cover is screwed on, thereby closing the discharge channel.

In an internal combustion engine or in a motor vehicle it is principally possible that a plurality of such filter devices is provided, for example, to be able to filter lubricating oil on the one hand and fuel on the other hand. Principally, these filter devices can be structured relatively similar so that it is basically possible that confusion between the filter elements can occur. However, due to its filter material, a filter element intended for filtering fuel is not suitable for cleaning lubricating oil and vice versa. When using a wrong filter element, the danger of damage to the internal combustion engine or any other system supplied with the liquid to be filtered increases.

The present invention is concerned with the problem to provide, for a filter system of the above mentioned type, an improved embodiment which is in particular characterized in that the danger of confusion between filter elements is reduced.

This problem is solved according to the invention by the subject matters of the independent claims. Advantageous embodiments are subject matter of the dependent claims.

The present invention is based on the general idea, for a filter system having at least two filter elements with eccentric plugs, to form the plugs of filter elements which are assigned to different filtering functions differently with respect to eccentricity and/or shape. With differently formed or arranged plugs, the respective filter element can only be used in cases where a suitable plug receptacle is available. Thereby, the danger of confusion between the filter elements is reduced.

By the provision of filter elements with plugs which are different with respect to eccentricity and/or shape, and in connection with the plug receptacles formed complementary thereto, a coding for the filter elements can be implemented in such a manner that, at the respective mounting location, only the correctly coded filter element can be inserted properly in such a manner that the respective plug penetrates properly into the associated complementary plug receptacle.

In a filter system that has three or more filter elements, at least two filter elements can look identical while at least two filter elements are different with respect to eccentricity and/or shape of the plug. It is also possible that all filter elements are formed differently with respect to shape and/or eccentricity of the plug.

Conceivable is, for example, a filter system for cleaning a lubricating oil of an internal combustion engine which can be arranged in particular in a motor vehicle and which has two parallelly operating identical filter elements for cleaning a main flow of the lubricating oil, and which has a further different filter element for cleaning a secondary flow of the lubricating oil. In comparison with the two main flow filter elements, the secondary flow filter element is designed for a significantly smaller volume flow and for filtering smaller contaminants. By means of the construction according to the invention, confusion between the filter elements of main flow and secondary flow can be avoided here so that the functionality of the main flow cleaning and the secondary flow cleaning can be better ensured. Particularly advantageous is an embodiment in which the filter system has a common console for attaching two or more filter elements. Hereby, installation space is saved. At the same time, the maintenance of the filter system is simplified because the filter elements have to be replaced at one location only.

For the respective filter element, the plug receptacle can principally be formed as blind hole or stud hole, and thus has basically no further function other than receiving the plug. Alternatively, for at least one of the filter elements, the plug receptacle can be formed by an inlet region of a return channel or discharge channel communicating with the crude chamber. Hereby, in connection with the plug receptacle formed by the return channel or discharge channel, the plug takes over an additional function, namely blocking the return channel or the discharge channel when penetrating into the plug receptacle. When the plug is missing or when the filter element is missing, or in general, when the complementary plug is not inserted into the plug receptacle, liquid supplied through the supply channel into the filter housing can discharge again to a substantial portion through the return channel or discharge channel, for example into a reservoir, from where a suitable conveying device conveys the liquid to the inlet. In this manner, a desired pressure, for example in the outlet, can not build up. Also, by using coded filter elements, the danger of confusion can be reduced here which allows a safe operation of the system, e.g. internal combustion engine and/or motor vehicle, equipped with the filter system.

Further important features and advantages arise from the sub-claims, from the drawings, and from the associated description of the Figures based on the drawings.

It is to be understood that the above mentioned features and the features yet to be explained hereinafter can be used not only in the respectively mentioned combination but also in other combinations or alone without departing from the scope of the present invention.

Preferred exemplary embodiments of the invention are illustrated in the drawings and are explained in the following description in more detail, wherein identical reference numbers refer to identical, or similar, or functionally identical components.

In the Figures:

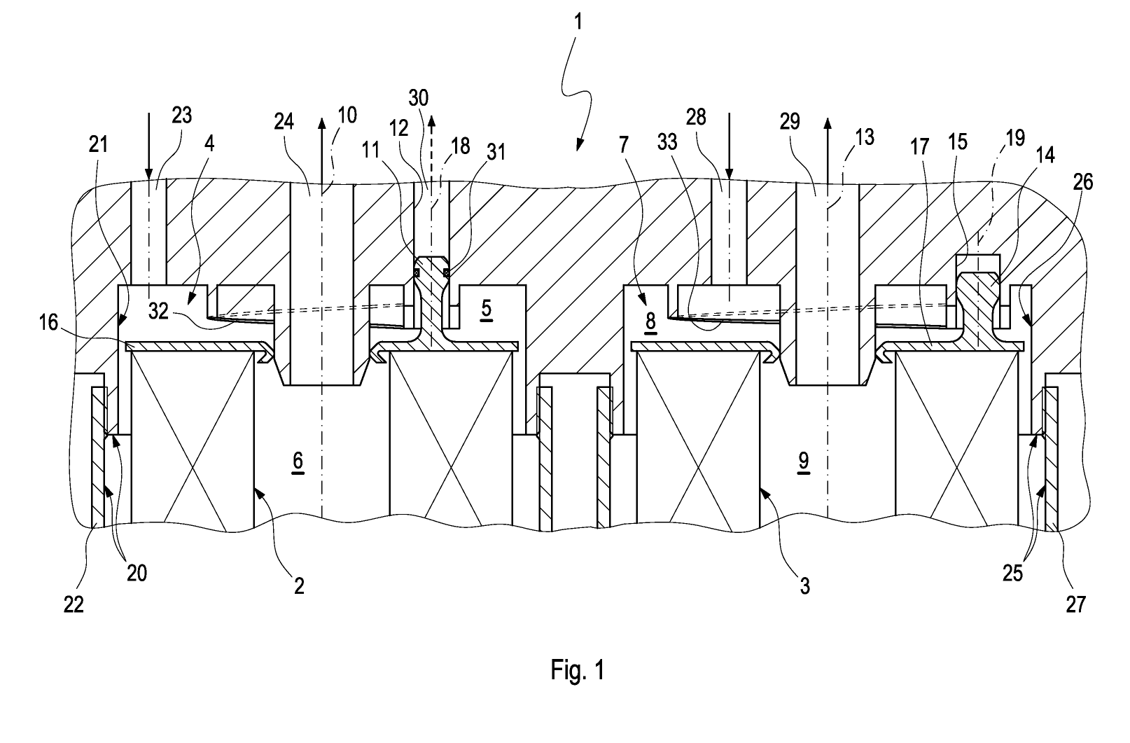

FIG. 1 shows schematically a cross section of a filter system with two filter elements, in each case in the region of a plug receptacle,

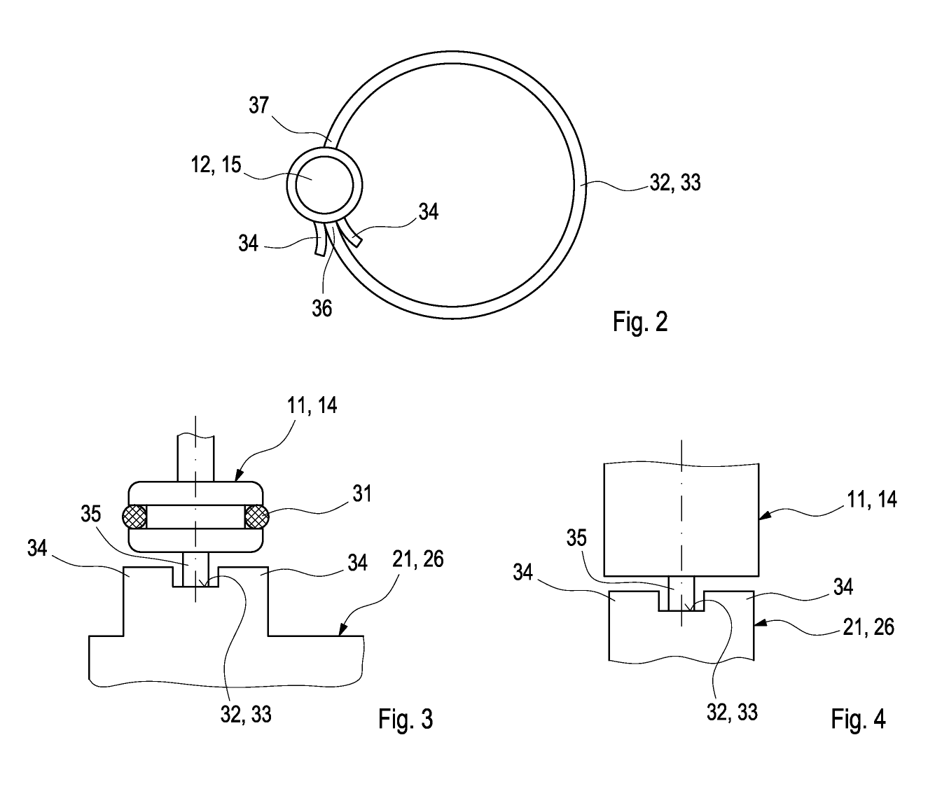

FIG. 2 shows schematically a greatly simplified top view of a ramp,

FIGS. 3 and 4 each show schematically greatly simplified views of a plug in the region of the ramp in different embodiments.

According to FIG. 1, a filter system 1 comprises an annular first filter element 2 and an annular second filter element 3. Principally, at least one further annular filter element can be provided. The filter system 1 serves for filtering a liquid, in particular of a motor vehicle or an internal combustion engine which can preferably be arranged in a motor vehicle.

For the first filter element 2, the filter system 1 has a first filter chamber 4 in which the first filter element 2 is inserted and in which the first filter element 2 separates a crude side 5 from a clean side 6. In the example, the flow through the first filter element 2 runs radially from the outside inwards so that the clean side 6 is inside the first filter element 2. The same applies to the second filter element 3. It is inserted into a second filter chamber 7 and separates therein a crude side 8 from a clean side 9 which, here too, is arranged inside the second filter element 3.

The first filter element 2 has a first plug 11 which projects axially and eccentrically with respect to a longitudinal center axis 10 of the first filter element 2 and which projects into a first plug receptacle 12 when the first filter element 2 is properly inserted into the first filter chamber 4. Analogously, also the second filter element 3 has a second plug 14 which projects axially and eccentrically with respect to a longitudinal center axis 13 of the second filter element 3 and which projects into a second plug receptacle 15 when the second filter element 3 is properly inserted into the second filter chamber 7. The first plug 11 is formed on an axial end disk 16 of the first filter element 2. Equally, the second plug 14 is formed on an axial end disk 17 of the filter element 3.

In the examples shown here, the respective plug 11, 14 is preferably formed on the respective end disk 16, 17. For example, the plug 11, 14 is integrally formed on the associated end disk 16, 17. Also, the plug 11, 14 can be completely or partially attached to the associated end disk 16, 17.

To avoid confusion between the two filter elements 2, 3, they differ from one another at least in the region of the plug 11, 14. For this purpose, the plugs 11, 14 can have different eccentricities. Additionally or alternatively, the plugs 11, 14 can differ from another with respect to their shape. In the shown example, the first plug 11 of the first filter element 2 has a smaller eccentricity than the second plug 14 of the second filter element 3. Here, the eccentricity is the distance between the longitudinal center axis 10, 13 of the respective filter element 2, 3 and a longitudinal center axis 18 or 19 of the respective plug 11, 14. Moreover, in the example, a different shape for the plugs 11, 14 is indicated. For example, the first plug 11 can be formed axially longer than the second plug 14. In the example, the first plug 11 also has a smaller cross section than the second plug 14.

In case that in another embodiment more than two filter elements 2, 3 are provided, thus, at least one further annular filter element can be provided which also separates a crude side from a clean side within an associated further filter chamber and which, preferably on an axial end disk, can also have a further plug which projects axially and eccentrically with respect to a longitudinal center axis of the respective filter element. Also, this further filter element can be equipped without such a plug. If, however, the further filter element is equipped with such a plug, the same projects axially into an associated further plug receptacle when the further filter element is properly inserted into the further filter chamber. In case of three or more filter elements 2, 3, each of them having one plug 11, 14, the plugs 11, 14 of all filter elements 2, 3 can be different with respect to eccentricity and/or shape. Also possible is an embodiment for which, at least in two filter elements, the plugs are identical with respect to eccentricity and/or shape. For example, the filter system 1 can use two identical filter elements for filtering a main flow in which case confusion has no impact.

According to FIG. 1, the first filter chamber 4 is arranged in a first housing 20 comprising a first console 21 and a first cover 22. The first console 21 has a first inlet 23 on the crude side which inlet communicates with the crude side and a first outlet 24 on the clean side which outlet communicates with the clean side 6. The first cover 22 can be fastened on the first console 21, e.g. by means of a screw connection or a bayonet lock.

In a corresponding manner, the second filter chamber 7 is formed within a second housing 25 which has a second console 26 and a second cover 27. The second console 26 has also a second inlet 28 on the clean side which inlet communicates with the associated clean side 8 and a second outlet 29 on the clean side which outlet communicates with the associated clean side 9. The second cover 27 can be fastened on the second console 26. In the shown example, the two housings 20, 25 have a common console 21-26. Also conceivable is an embodiment in which each housing 20 has a separate console 21, 26. The common console 21-26 shown here thus comprises the two inlets 22, 28, the two outlets 24, 29, and the two filter chambers 4, 7. However, the two covers 22, 27 are separate in such a manner that the two filter elements 2, 3 can be replaced separately and independently from one another.

In the exemplary embodiment shown in FIG. 1, the second plug receptacle 15 is formed as blind hole. In particular, this blind hole or the second plug receptacle 15 has no further functionality besides the capability to receive the second plug 14. In contrast to that, the first plug receptacle 12 is formed by an inlet region of a return channel or discharge channel 30 which is incorporated in the first console 21, or here, in the common console 21-26 and which communicates with the first crude chamber 5. The first plug 11 fulfils here, in addition, the function to close the discharge channel or the return channel 30 when it is inserted into the first plug receptacle 12, thus into the inlet region of the return channel or discharge channel 30. The first plug 11 can be equipped with a suitable radial seal 31 which, for example, involves an O-ring. For the second plug 14, which interacts only with a second plug receptacle 15 formed as blind hole, such a radial seal is not necessary. It is clear that also the second plug receptacle 15 can be formed by a return channel or discharge channel.

According to FIG. 1, the filter elements 2, 3 in the respective filter housing 20, 25 can be arranged in a suspended manner. It is clear that basically a standing arrangement for the filter elements 2, 3 in the respective filter housing 20, 25 is also possible. Furthermore, a lying arrangement for the filter elements 2, 3 within the respective filter housing 20, 25 can also be implemented. The terms “suspended”, “standing”, and “lying” are oriented here with respect to horizontal or vertical environmental axes.

According to FIG. 1, at least one of the plug receptacles 12, 15 can be assigned to a ramp 32 or 33. In the example, such a ramp 32, 33 is assigned here to each of the plug receptacles 12, 15. The respective ramp 32, 33 is circularly shaped and leads towards the respective plug receptacle 12, 15. For this purpose, the ramp 32, 33 descends helically towards the plug receptacle 12, 15. The plug 11, 14 associated to the respective ramp 32, 33 can slide along the same when screwing in the filter element 2, 3. By means of such a ramp 32, 33, the insertion of the respective plug 11, 14 into the associated plug receptacle 12, 15 is considerably simplified. As is apparent here, the two ramps 32, 33 differ from one another in their respective radius which is selected complementary to the eccentricity of the associated plug 11, 14.

If the filter system 1 is equipped with at least one such ramp 32, 33, a specific embodiment illustrated in more detail in particular in the FIGS. 2 to 4 can be implemented for at least one of these ramps 32, 33. In these specific embodiments, the respective ramp 32, 33 and the associated plug 11, 14 are formed and adjusted to one another in such a manner that they interact according to the key-lock-principle. This key-lock-principle has the effect that only such filter elements 2, 3 can properly be used with the filter system 1 for which the plug 11, 14 is specifically adapted to the ramp 32, 33. Here, the relevant and proper use includes that the respective plug 11, 14, when attaching or rotating the filter element 2, 3, finds the plug receptacle 12 or 15 automatically and penetrates into it. In case of filter elements 2, 3 which are not specifically adapted to the filter system 1, the key-lock-principle prevents that the potentially existing plug 11, 14 can automatically find the plug receptacle 12, 15 when screwing in the filter element 2, 3, even if it has a suitable eccentricity. Hereby is intended to achieve that only filter elements 2, 3 can be used which are accurately adapted for the filter system 1, for example, to be able to ensure a proper filter function.

To implement this key-lock-principle, according to FIGS. 2 to 4, an insertion contour with guiding bodies 34 can be provided, which can be arranged on one side or on both sides of the ramp 32, 33 and which project axially beyond the ramp 32, 33. A plug 11, 14 sliding downwards along the ramp 32, 33 can reach the associated plug receptacle 12, 15 only when it has a projection 35 which is adapted to the guiding bodies 34 and which projects axially from the respective plug 11, 14. This projection 35 is, for example, a tapered or pin-shaped or rib-shaped lug which establishes the contact between the plug 11, 14 and the ramp 32, 33. This projection 35 is axially dimensioned in such a manner that it can lift the plug 11, 14 across the guiding elements 34. This means, the plug 11, 14, which slides via the projection 35 on the ramp 32, 33, is spaced apart far enough from the guiding bodies 34 that it can be oriented passing along the guiding bodies 34 in alignment with the plug receptacle 12, 15. According to the FIGS. 2 to 4, this projection 35 can contact the ramp 32, 33 between and through the guiding bodies 34, thereby allowing the sliding of the plug 11, 14.

According to FIG. 2, the guiding bodies 34 are arranged in the region of a lower ramp end 36. The plug receptacle 12, is arranged in circumferential direction between the lower ramp end 36 and an upper ramp end 37 which descends along the ramp 32, 33 in a helically manner along a circular path towards the lower ramp end 36.

Apart from that, with respect to the key-lock-principle and with respect to its implementation, reference is made to the above mentioned EP 1 229 985 B1, which hereby is added by means of explicit reference to the disclosure content of the present invention.

As already mentioned, the first filter element 2 and the second filter element 3 can serve for cleaning the same liquid, wherein the first filter element 2 is designed as main flow filter while the second filter element 3 is designed as secondary flow filter. Also, two parallelly operating main flow filters can be provided which can be formed identically, in particular with respect to their plug. Such a filter system 1 is conceivable, for example, for a lubricating oil circuit of an internal combustion engine for a commercial vehicle. There, for example, two identical filter elements can serve as main flow filter whereas a further filter element, which is different with respect to the plug, serves as secondary flow filter.

Furthermore, principally also possible is an embodiment in which the first filter element 2 is designed for cleaning a first liquid, for example lubricating oil, whereas the second filter element 3 is designed for cleaning a second liquid which is different from the first liquid, for example fuel. Other liquid systems which can be considered for the use of such a filter system 1 are, for example, a coolant circuit for an internal combustion engine and a break liquid circuit for a motor vehicle, as well as any other hydraulic circuits.

1. A liquid filter system, comprising:
an annular first filter element in a first filter chamber, wherein the filter element separates a crude side from a clean side in the first filter chamber, wherein the first filter chamber and has a first plug, which projects axially and eccentrically with respect to a longitudinal center axis of the first filter element and extends axially into a first plug receptacle after insertion in a properly inserted state in the first filter chamber; and
an annular second filter element in a second filter chamber, wherein the filter element separates a crude side from a clean side in a second filter chamber, wherein the second filter chamber has a second plug, which projects axially and eccentrically with respect to a longitudinal center axis of the second filter element and extends axially into a second plug receptacle after insertion in the second filter chamber, and wherein the filter elements differ from one another at least in that the plugs have at least one of different eccentricities and shapes.

2. The filter system according to claim 1, wherein the different shapes of the plugs are formed by at least one of different cross sections and different axial lengths.

3. The filter system according to claim 1 wherein at least one additional annular filter element is provided, which separates, respectively, a crude side from a clean side in an associated filter chamber and wherein the chamber has at least one of no plug and one plug, wherein when one plug is included the plug projects axially and eccentrically with respect to a longitudinal center axis and extends axially into an associated further plug receptacle in a properly inserted state in the further filter chamber, wherein the plugs are different with respect to at least one of eccentricity for all filter elements, shape for all filter elements and are identical for at least two filter elements.

4. The filter system according to claim 1, wherein the respective filter chamber is arranged in an associated housing that is formed by a console, which has at least one inlet on the crude side and one outlet on the clean side, and by one cover fastenable on the console, wherein either at least one of each housing has its own console and at least two housings have a common console.

5. The filter system according to claim 1, wherein at least one of the plug receptacles is assigned to a circularly shaped ramp between lower and upper ends of which the respective plug receptacle is arranged, and on which the plug of the associated filter element can slide when inserting the respective filter element into the respective filter chamber while the respective filter element rotates about its longitudinal center axis.

6. The filter system according to claim 1, wherein at least one of the plug receptacles is formed as blind hole, and by an inlet region of a return channel on at least one of the crude side and a discharge channel on the crude side.

7. The filter system according to claim 1, wherein the first filter element and the second filter element clean the same liquid, wherein the first filter element is a main flow filter and the second filter element is a secondary flow filter.

8. The filter system according to claim 1, wherein the first filter element cleans a first liquid and the second filter element cleans a second liquid, which is different from the first liquid.

9. An internal combustion engine, comprising: at least one liquid system including, at least one of a fuel supply, a lubricating oil circuit, and a cooling system, wherein the liquid system further includes a filter system, wherein the filter system comprises an annular first filter element in a first filter chamber, wherein the filter element separates a crude side from a clean side in the first filter chamber, wherein the first filter chamber has a first plug, which projects axially and eccentrically with respect to a longitudinal center axis of the first filter element and extends axially into a first plug receptacle after insertion in the first filter chamber; and an annular second filter element in a second filter chamber, wherein the filter element separates a crude side from a clean side in a second filter chamber, wherein the second filter chamber has a second plug, which projects axially and eccentrically with respect to a longitudinal center axis of the second filter element and extends axially into a second plug receptacle after insertion in the second filter chamber, and wherein the filter elements differ from one another at least in that the plugs have at least one of different eccentricities and shapes.

10. A vehicle with at least one liquid system, comprising:
an internal combustion engine having at least one filter system integrated in at least one of a fuel supply, a lubricating oil circuit, a coolant circuit, a break liquid circuit and a hydraulic circuit, wherein the filter system includes at least one annular filter that separates a crude side from a clean side in a first chamber, wherein the first chamber includes a first plug, which projects axially and eccentrically with respect to a longitudinal center axis of the first filter element and extends axially into a first plug receptacle after insertion in the first filter chamber.

11. The internal combustion engine according to claim 9, wherein the different shapes of the plugs are formed by at least one of different cross sections and different axial lengths.

12. The internal combustion engine according to claim 9, wherein at least one additional annular filter element is provided, which separates, respectively, a crude side from a clean side in an associated filter chamber and wherein the chamber has at least one of no plug and one plug, wherein when one plug is included the plug projects axially and eccentrically with respect to a longitudinal center axis and extends axially into an associated further plug receptacle in a properly inserted state in the further filter chamber, wherein the plugs are different with respect to at least one of eccentricity for all filter elements, shape for all filter elements and are identical for at least two filter elements.

13. The internal combustion engine according to claim 9, wherein the respective filter chamber is arranged in an associated housing that is formed by a console, which has at least one inlet on the crude side and one outlet on the clean side, and by one cover fastenable on the console, wherein either at least one of each housing has its own console and at least two housings have a common console.

14. The internal combustion engine according to claim 9, wherein at least one of the plug receptacles is assigned to a circularly shaped ramp between lower and upper ends of which the respective plug receptacle is arranged, and on which the plug of the associated filter element can slide when inserting the respective filter element into the respective filter chamber while the respective filter element rotates about its longitudinal center axis.

15. The internal combustion engine according to claim 9, wherein at least one of the plug receptacles is formed as blind hole, and by an inlet region of a return channel on at least one of the crude side and a discharge channel on the crude side.

16. The internal combustion engine according to claim 9, wherein the first filter element and the second filter element clean the same liquid, wherein the first filter element is a main flow filter and the second filter element is a secondary flow filter.

17. The internal combustion engine according to claim 9, wherein the first filter element cleans a first liquid and the second filter element cleans a second liquid, which is different from the first liquid.

18. The vehicle liquid system according to claim 10, further comprising: an annular second filter element in a second filter chamber, wherein the filter element separates a crude side from a clean side in a second filter chamber, wherein the second filter chamber has a second plug, which projects axially and eccentrically with respect to a longitudinal center axis of the second filter element and extends axially into a second plug receptacle after insertion in the second filter chamber, and wherein the filter elements differ from one another at least in that the plugs have at least one of different eccentricities and shapes.

19. The vehicle liquid system according to claim 10, wherein at least one additional annular filter element is provided, which separates, respectively, a crude side from a clean side in an associated filter chamber and wherein the chamber has at least one of no plug and one plug, wherein when one plug is included the plug projects axially and eccentrically with respect to a longitudinal center axis and extends axially into an associated further plug receptacle in a properly inserted state in the further filter chamber, wherein the plugs are different with respect to at least one of eccentricity for all filter elements, shape for all filter elements and are identical for at least two filter elements.

20. The vehicle liquid system according to claim 10, wherein the respective filter chamber is arranged in an associated housing that is formed by a console, which has at least one inlet on the crude side and one outlet on the clean side, and by one cover fastenable on the console, wherein either at least one of each housing has its own console and at least two housings have a common console, wherein at least one of the plug receptacles is assigned to a circularly shaped ramp between lower and upper ends of which the respective plug receptacle is arranged, and on which the plug of the associated filter element can slide when inserting the respective filter element into the respective filter chamber while the respective filter element rotates about its longitudinal center axis, and wherein the first filter element and the second filter element clean at least one of different liquids and the same liquid, and wherein the first filter element is a main flow filter and the second filter element is a secondary flow filter.
